(19) United States
(12) Patent Application Publication
(10) Pub. No.: US 2013/0268396 A1
(43) Pub. Date: Oct. 10, 2013

(54) METHOD AND SYSTEM FOR PROVIDING PERSONALIZED APPLICATION RECOMMENDATIONS

(71) Applicants: Markus Agevik, Malmo (SE); Andreas Munchmeyer, Rydeback (SE); Jonas Olsson, Lund (SE)

(72) Inventors: Markus Agevik, Malmo (SE); Andreas Munchmeyer, Rydeback (SE); Jonas Olsson, Lund (SE)

(73) Assignee: Sony Mobile Communications AB

(21) Appl. No.: 13/640,838

(22) PCT Filed: Sep. 6, 2011
(86) PCT No.: PCT/IB11/02056

§ 371 Date: Oct. 12, 2012

(51) Int. Cl. G06Q 30/06

(52) U.S. Cl. CPC G06Q 30/0631
USPC 705/26.7

(57) ABSTRACT

A method and system for providing personalized application recommendations to users of electronic devices. Contextual information is used to build a personalized user knowledge base. The information stored in the personalized user knowledge base may be used to locate applications that may be of interest to the user.

### TECHNICAL FIELD OF THE INVENTION

The present invention relates to electronic devices and applications installed thereon, and more particularly to methods and systems for providing users with personalized application recommendations based on contextual information associated with the users.

### DESCRIPTION OF THE RELATED ART

In recent years, portable electronic devices, such as mobile phones, personal digital assistants, mobile terminals, etc., continue to grow in popularity. Consequently, today's portable electronic device landscape is rapidly changing. The features associated with certain types of portable electronic devices have become increasingly diverse. To name a few examples, many portable electronic devices have cameras, text and multimedia messaging capability, internet browsing functionality, electronic mail capability, video playback capability, audio playback capability, image display capability, position sensing capability and hands-free headset interfaces.

With the rapid expansion of portable electronic device functionality, portable electronic device operating systems have been developed to allow users to install additional applications on their portable electronic devices. Such applications may be available through large application stores, which may offer hundreds of thousands of application choices for users.

### SUMMARY

Accordingly, there is a need in the art for a method and system for providing users with improved experiences while using portable electronics devices. In particular, there is a need in the art for an improved method and system for identifying for users applications that may be of interest to users based on personalized contextual information. The applications may include web applications or software applications for installation on the portable electronic device.

According to one aspect of the invention, a method is provided for providing application recommendations (sometimes referred to herein as “suggestions”) to a user of an electronic device. The method may include: receiving personalized contextual information corresponding to the user; using the received personalized contextual information to build an accumulated personalized user knowledge base; based at least in part on information stored in the personalized user knowledge base, selecting at least one relevant application for at least one of the user's electronic device or an accessory associated with the user's electronic device; and notifying the user of the existence of the at least one relevant application.

According to one aspect of the invention, notifying the user may include recommending (suggesting) a relevant application.

According to one aspect of the invention, the contextual information may include at least one of: information collected from a sensor on the portable electronic device or accessory, personal user information stored on the portable electronic device or accessory, events or scheduling information relating to the user, places visited by the user, events attended by the user, social networks with which the user is associated, or devices to which the user has connected via at least one of the user's electronic device or an accessory associated with the user's electronic device.

According to one aspect of the invention, personal interest information may be derived at least in part from the user's internet activity.

According to one aspect of the invention, the user preferences may include at least one of: multimedia preferences, media playback preferences, menu settings, or settings on the user's electronic device.

According to one aspect of the invention, the contextual information may include information relating to at least one of: information collected from a sensor on the portable electronic device or accessory, personal user information stored on the portable electronic device or accessory, events or scheduling information relating to the user, places visited by the user, events attended by the user, social networks with which the user is associated, or devices to which the user has connected via at least one of the user's electronic device or an accessory associated with the user's electronic device.

According to one aspect of the invention, the contextual information may be based at least in part on the user's web browsing activities.

According to one aspect of the invention, the personalized user knowledge base may be stored in cloud storage.

According to one aspect of the invention, the contextual information may be collected at least in part through computer readable code on non-transitory computer readable medium on at least one of the following: a computer, a portable electronic device, or an accessory for a portable electronic device. In addition, at least part of the contextual information may be stored on a non-transitory computer readable medium on at least one of the following: a computer, a portable electronic device, or an accessory for a portable electronic device.

According to one aspect of the invention, the method may further include determining whether there exists any relevant application corresponding to information stored in the personalized user knowledge base.

According to one aspect of the invention, the method may further include determining whether the at least one relevant application is installed on the user's electronic device.

According to one aspect of the invention, the step of notifying the user of the existence of the relevant application may be triggered either directly or indirectly by at least one of: scheduling information, timing information, sensor information, incoming events, user activity on the user's electronic device, user activity on the accessory associated with the user's electronic device, a change in location of the user's electronic device, or a change in location of the accessory associated with the user's electronic device.

According to one aspect of the invention, selecting a relevant application may be triggered at least in part by a comparison of user activity information or scheduling information and user location information. In addition, selecting a relevant application may be triggered at least in part by a determination that user activity information or scheduling information share a common variable with the user's location information within a predefined period of time.

According to one aspect of the invention, the user's electronic device may be a portable electronic device. In addition, the relevant application may be selected from a plurality of applications available to the user's portable electronic device via an application store.

According to one aspect of the invention, personalized contextual information corresponding to the user is received in an automated manner.

According to one aspect of the invention, personalized contextual information corresponding to the user is received in a manual manner.

According to one aspect of the invention, the type of personalized contextual information is controlled by the user.

According to another aspect of the invention, there is provided a system for providing application recommendations to a user of an electronic device. The system may include computer readable code on at least one non-transitory computer readable medium, wherein the computer readable code is adapted to perform the method steps of any aspect of the invention.

According to another aspect of the invention there is provided a portable electronic device having an operating system adapted for installation of applications. The portable electronic device includes a memory; a user interface; a controller coupled to the memory; and computer readable code stored on a computer-readable medium. When the computer readable code is executed, the computer readable code causes the portable communication device to: gather user contextual information comprising at least one of: personal interest information, location information, scheduling information, timing information, or information relating to applications installed on the portable electronic device, transmit the contextual information for incorporation into a cloud based user knowledge base, receive a recommended application, and cause the user interface to indicate to the user the existence of the recommended application.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic diagram of a system implementing methods according to the present invention;

FIG. 2 depicts an exemplary methodology for suggesting application to a user of an electronic device;

FIG. 3 depicts an exemplary flow chart for using contextual information to identify relevant applications;

FIG. 4 depicts a diagram generally illustrating a key word method for finding relevant applications to recommend to a user; and

FIG. 5 depicts a flow chart generally illustrating a method for finding and recommending applications to a user.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

The present invention provides personalized application suggestions or recommendations to users of electronic devices. In one embodiment, personalized contextual information, such as personal interest information, location information, scheduling information, timing information, or sensor (e.g., gyroscope, accelerometer, GPS sensor, or the like) information is used to build a personalized user knowledge base. The contextual information stored in the personalized user knowledge base may be used to locate applications that may be of interest to the user. In one embodiment, the personalized knowledge base is in cloud storage, and contextual information is derived in part in an automated manner from a user's computing activities, use of a portable electronic device, or physical location.

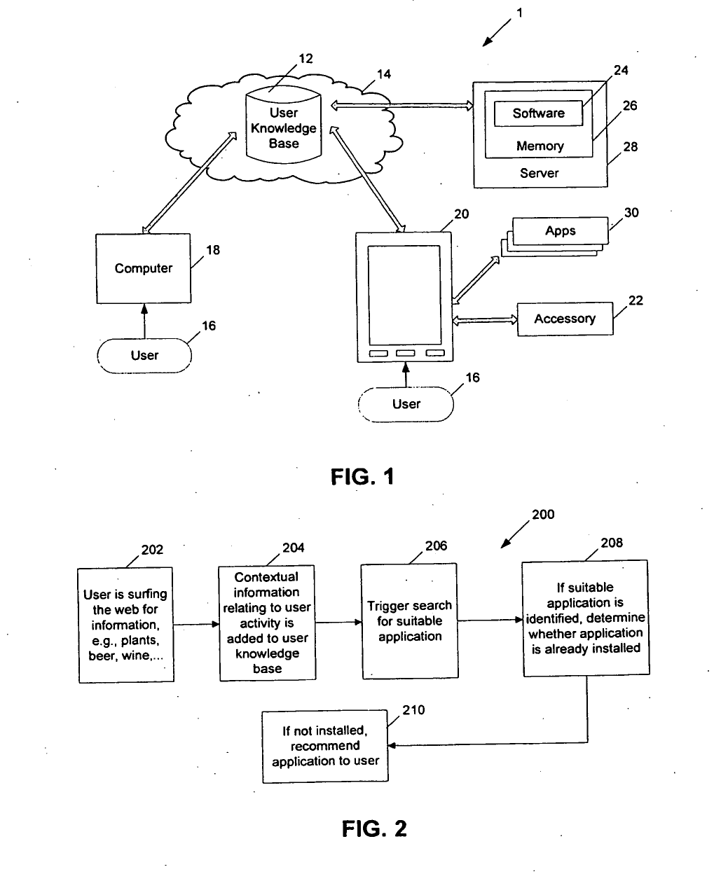

With reference to FIG. 1, an exemplary schematic diagram of a system 1 implementing methods according to the present invention is provided. The system is adapted to store contextual information about the user 16 to build a user knowledge base 12, which may be in cloud storage, such as in cloud 14, which may be accessible to the user 16 via a plurality of different mechanisms, e.g., computer 18, portable electronic device 20 or an accessory 22 to portable electronic device 20. Software 24, i.e., computer readable code, which may be stored on memory 26 of, for example, a server 28, may then use the information stored in the user knowledge base 12 to determine whether there are any applications 30 relevant to the information in the user knowledge base 12. The applications 30 may be selected from a plurality of applications 30 available to the user's portable electronic device 20 via an application store. As used herein, an application 30 may be a software program designed for installation on a device, such as the portable electronic device 20, a service, or web based application. Once applications 30 are identified as potentially relevant to the user 16, they may be recommended to the user 16. It will be apparent to a person of ordinary skill in the art that the locations of the elements of FIG. 1 need not be as shown in the illustrative embodiment. For example, the applications 30 may be stored in cloud storage or the server 28 could be incorporated into the portable electronic device 20.

It will be apparent to a person having ordinary skill in the art of computer programming, how to program the software 24 on the server 28 to search the user knowledge base 12 to operate and carry out the associated logical functions. Accordingly, details as to specific programming code have been left out for the sake of brevity. Also, while the software 24 stored in memory 26 may be executed by the server 28, such as by a processor of the server, in accordance with an exemplary embodiment, such functionality could also be carried out via other types of dedicated hardware, firmware, software, or combinations thereof, without departing from the scope of the invention.

The exemplary computer 18 may be any type of general purpose or specific purpose computer. The exemplary portable electronic device 20 may be any type of portable electronic device or combination of devices capable of installing applications 30. Such devices include but are not limited to mobile phones, digital cameras, digital video cameras, mobile PDAs, tablets, other mobile radio communication devices, gaming devices, portable media players, or the like. It will also be appreciated that the “portable electronic device” of present invention is not limited to “portable” devices and instead is directed to devices capable of installing applications. According, the portable electronic device 20 may be embodied in computers, including desktops, laptops, tablets and the like, as well as in television and home theater settings. Thus, while the present description discussed portable electronics devices, it should be understood that the methods described herein are applicable to any type of device having an operating system adapted for the installation of applications 30 and that the “portable electronic device” need not be “portable” and may in fact be incorporated into other non-portable devices or structures.

In the most common scenario, the exemplary portable electronic device 20 is a mobile phone, which may include a user interface, which may include a display, which may be a touch sensitive display, a camera assembly, and may further include additional user interface devices, such as a directional pad or other buttons. The portable electronic device 20 may also include a primary control circuit that is configured to carry out overall control of the functions and operations of the electronic device. The control circuit may include a processing device, such as a CPU, microcontroller or microprocessor. Among their functions, to implement the features of the present invention, the control circuit and/or processing device may comprise a controller that may execute computer readable code stored in memory.

The accessory 22 may be any electronic device, but is preferably an electronic device adapted to communicate with the portable electronic device 20. The accessory 22 and the portable electronic device 20 may communicate using any suitable long range or short range communication protocol. In one illustrative embodiment, the accessory 22 and portable electronic device 20 communicate using short range communication protocol such as, for example, Bluetooth®, Near Field Communication (NFC), Wi-Fi, radio frequency or the like. For example, the accessory 22 may be an electronic device that is worn by the user. Like the portable electronic device 20, the accessory 22 may also have a display for displaying information to the user 16, as well as other user interface devices, such as buttons or a touch sensitive display.

The present invention provides for personalized suggestions or recommendations for applications 30 based on personalized contextual information corresponding to a user 16. There are numerous mechanisms, which may be used individually or in combination, for collecting contextual information. For example, contextual information may be derived from internet searches performed by a user 16 at a computer 18, portable electronic device 20, or accessory 22. The device with which the user 16 performs the internet search may include software designed to automatically gather information about the user's personal interests, schedule, applications 30 installed on the device, or user preferences for the device. For example, the user's calendar, particularly appointments, may provide useful contextual information. A calendar event, such as a holiday, anniversary, birthday, or doctor's appointment, may influence the type of application 30 that is recommended to a user. For example, if a user's friend has an upcoming birthday, the system may recommend a greeting card application 30.

Also, the user preferences may include, for example, multimedia preferences, media playback preferences, menu settings, and the like. In addition, the software may also gather timing information associated with the user's access of other information. For example, the software may be configured to store the nature of a search as well as the time during which the search was performed.

It will be understood by those skilled in the art that contextual information may include any type of information about or relating to a user. For example, contextual information may include, but is not limited to, information relating to websites visited by the user of the portable communication device 20 or computer 18, contacts, e.g., phone contacts, mail contacts, and the like, stored within the portable communication device 20, computer 18 or on an external service accessible via the portable communication device 20 or computer 18, music played through or otherwise stored on the portable communication device 20 or computer 18, podcast stations, portable recording and playback device settings, e.g., digital video recorder settings, internet content preferences, streaming media content preferences and the like, and other settings such as theme or user-entered search criteria, priorities or the like. The contextual information also may relate to, for example, places visited by the user, events attended by the user, social networks with which the user is associated, or devices to which the user has connected. It will be appreciated that aspects of the invention are not limited to a certain number or nature of user activities and/or user preferences. Moreover, as portable communication devices continue to evolve in terms of functionality and capability, more and more user activities and/or user preferences may be tracked to identify personalized contextual information suitable for building a personalized user knowledge base.

The contextual information may be gathered automatically, manually or using a combination of automated and manual processes. In addition, the computer 18, portable electronic device 20 or accessory 22 may include software that allows the user 16 to customize the nature of the contextual information and the manner in which contextual information is obtained. For example, gathering contextual information may be carried out automatically, e.g., by automatically tracking user activities, semi-automatically, e.g., by automatically tracking user activities and/or user preferences in combination with the user manually entering information relating to user activities and/or user preferences, and/or manually, e.g., by the user manually entering information related to user activities and/or user preferences. It will be appreciated that the present invention is not limited to any particular methodology or algorithm for creating, gathering or organizing contextual information.

The contextual information may also include location information, which may be obtained in a variety of ways. For example, location information may be determined by the device itself, provided from the network, determined through coordination between the device and the network, or may be entered manually by the user. For example, location information may be determined by receipt of location data from a dedicated system, such as a global positioning satellite (GPS), Galileo satellite system or the like, or connection to a Wi-Fi network. In addition, change in location information may also be gathered as contextual information to indicate, for example, the speed at which the user is traveling.

As shown, the user knowledge base 12 is stored in cloud 14. It should be understood by those of skill in the art that the user knowledge base 12 may also be locally stored. For example, each of the computer 18 and the portable electronic device 20 may have a version of the user knowledge base 12 stored thereon, and the differences between the two versions may be addressed using standard synchronization techniques. It is also possible to for the computer 18 and/or the portable electronic device 20 to perform all steps involved in the creation of the user knowledge base 12 and the application 30 selection. In this manner, software on the computer 18 and/or portable electronic device 20 would perform the functionality of the software 24 stored in memory 26 on the server 28.

Referring next to FIG. 2, an exemplary methodology or process 200 for suggesting application to a user of an electronic device is illustrated. Flow begins at process block 202, wherein a user browses the internet while searching for information. At process block 204, based at least in part on the user's web activity, contextual information is gathered and added to the personalized user knowledge database 12. A search for a suitable related application is triggered at process block 206. The trigger may be automated or manual, or combinations thereof. An automated search may be triggered by, for example, one or more of: scheduling information (e.g., a calendar event), timing information, sensor information (e.g., GPS, gyroscope, accelerometer, etc.), incoming events (e.g., email, SMS, RSS, instant message, etc.), user activity on the user's electronic device, user activity on the accessory associated with the user's electronic device, a change in location of the user's electronic device, a change in location of the accessory associated with the user's electronic device, or combinations thereof. In addition, timing information may be used to trigger a search for a relevant suitable application. For example, a search for an application may be triggered when internet activity information and location information share a common theme (e.g., user searches internet for wine reviews and then travels near a store where wine is sold) within a predefined period of time.

Flow then continues to process block 208 wherein, if a suitable relevant application is identified, a determination is made whether the identified application is already installed on the user's electronic device, such as portable electronic device 20. If the application is not already installed, it is recommended to the user at process block 210.

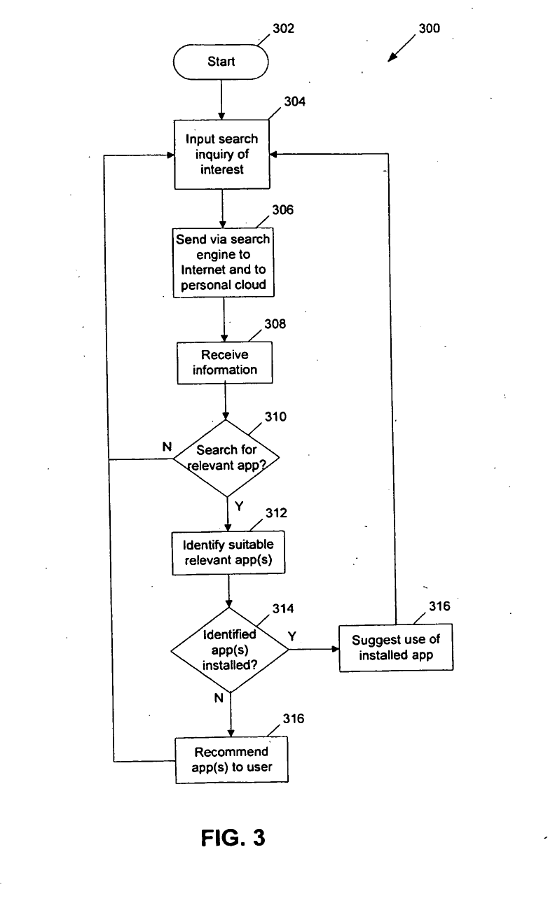

Turning next to FIG. 3, an exemplary flow chart representing a process 300 for using contextual information to identify relevant applications is provided. The process commences at start block 302, from which progression flows to process block 304. At process block 304, a user inputs a search inquiry of interest on an electronic device, e.g., a computer 18, a portable electronic device 20 or an accessory 22. The “input” from the user may be automated based on user activity or manually entered by the user. Flow then progresses to process block 306 wherein contextual information relating to the user's search inquiry is sent to the user's personal cloud. Computer readable code on the user's electronic device may be adapted to gather and send the contextual information.

Progression then continues to process block 308 wherein the contextual information is received by the system and added to the personalized user knowledge base, such as user knowledge base 12 stored in cloud 14. Flow then progresses to decision block 310 wherein a determination is made whether to search for a suitable relevant application. Such determination may be triggered by numerous events or combinations thereof. A negative determination at decision block 310 causes progress to loop back to process block 304. A positive determination at decision block 310 causes progression to process block 312 wherein at least one suitable relevant application is identified.

Progression than continues to decision block 314 wherein a determination is made whether the identified application(s) is (are) already installed on the user's electronic device. A negative determination at decision block 314 causes progression process block 316 wherein at least one application is recommended to the user. Progression then loops back to process block 304. A positive determination at decision block 314 causes progression to process block 318 wherein use of the installed selected application is recommended to the user. Progression then loops back to process block 304.

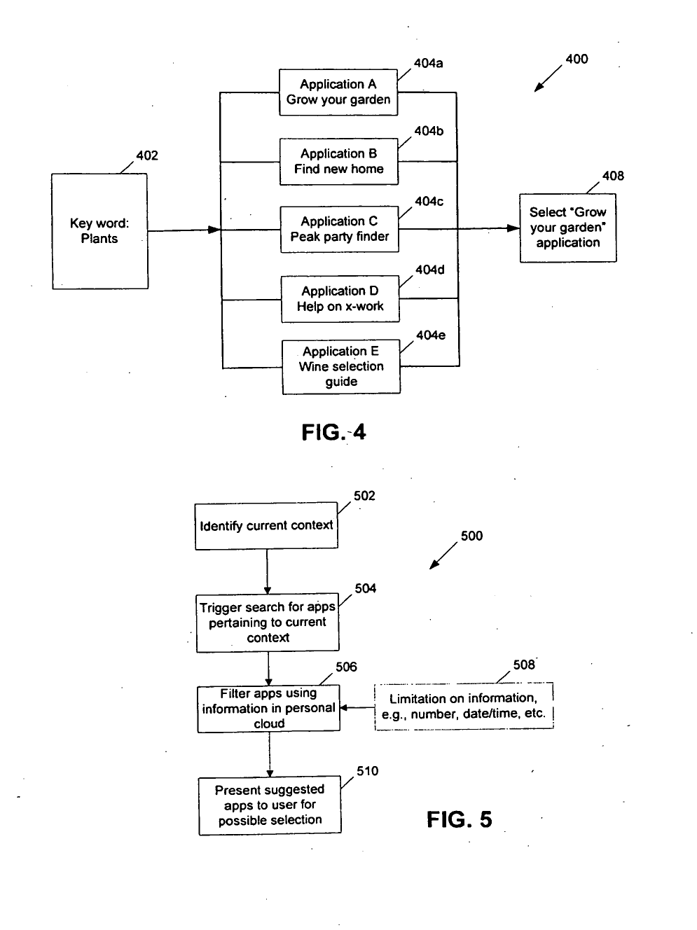

Turning next to FIG. 4, generally provided is a flow chart illustrating a key word method 400 for finding relevant applications to recommend to a user. Flow begins at process block 402 in which a key word is identified as a search term for finding relevant suitable applications. As shown, the key word is “plants.” The key word may be manually generated by the user or automatically generated based on the contextual information received. The key word is then used to identify applications, such as those shown in 404a through 404e. All of applications 404a-e may be generally relevant to the user's personalized user knowledge base, but they may not be specifically relevant to the user's current inquiry or activity. In the particular example illustrated, flow continues to process block 408 in which only the application called “Grow your garden” is selected for presentation to the user as being relevant to the search criteria.

Turning next to FIG. 5, a flow chart generally illustrating a method 500 for finding and recommending applications to a user is provided. Flow commences at process block 502 in which contextual information corresponding to the user's current activity is identified. Flow then continues to process block 504 wherein a search is triggered for applications relevant to the contextual information. Flow continues to process block 506 wherein information in the user knowledge base is used to filter search results. Process block 508 provides examples of potential filter criteria, such as number of applications, date, time, user activity, etc. Progression then continues to process block 510 wherein a selected application is presented to a user.

As will be appreciated by one of skill in the art, computer program elements and/or circuitry elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any non-transitory medium that can contain, store, or communicate, the program for use by or in connection with the instruction execution system, apparatus, or device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application. The present invention includes all such equivalents and modifications, and is limited only by the scope of the following claims.

1. A method for providing an application recommendation to a user of an electronic device comprising:
receiving personalized contextual information corresponding to the user;
using the received personalized contextual information to build a personalized user knowledge base;
based at least in part on information stored in the personalized user knowledge base, selecting at least one relevant application for at least one of the user's electronic device or an accessory associated with the user's electronic device; and
notifying the user of the existence of the at least one relevant application.

2. The method of claim 1 wherein the contextual information comprises at least one of: information collected from a sensor on the portable electronic device or accessory, personal user information stored on the portable electronic device or accessory, events or scheduling information relating to the user, places visited by the user, events attended by the user, social networks with which the user is associated, or devices to which the user has connected via at least one of the user's electronic device or an accessory associated with the user's electronic device.

3. The method of claim 2 wherein personal interest information is derived at least in part from the user's internet activity.

4. The method of claims 1 wherein the user preferences comprise at least one of: multimedia preferences, media playback preferences, menu settings, or settings on the user's electronic device.

5. The method of claim 1 wherein the contextual information comprises information relating to at least one of: information collected from a sensor on the portable electronic device or accessory, personal user information stored on the portable electronic device or accessory, events or scheduling information relating to the user, places visited by the user, events attended by the user, social networks with which the user is associated, or devices to which the user has connected via at least one of the user's electronic device or an accessory associated with the user's electronic device.

6. The method of claim 1 wherein the personalized user knowledge base is stored in cloud storage.

7. The method of claim 1 wherein the contextual information is collected at least in part through computer readable code on non-transitory computer readable medium on at least one of the following: a computer, a portable electronic device, or one or more accessories for a portable electronic device.

8. The method of claim 7 further comprising storing at least part of the contextual information on a non-transitory computer readable medium on at least one of the following: a computer, a portable electronic device, or an accessory for a portable electronic device.

9. The method of claim 1 further comprising determining whether there exists any relevant application corresponding to information stored in the personalized user knowledge base.

10. The method of claim 1 further comprising determining whether the at least one relevant application is installed on the user's electronic device.

11. The method claim 1 wherein the step of notifying the user of the existence of the relevant application is triggered either directly or indirectly by at least one of: scheduling information, timing information, sensor information, incoming events, user activity on the user's electronic device, user activity on the accessory associated with the user's electronic device, a change in location of the user's electronic device, or a change in location of the accessory associated with the user's electronic device.

12. The method of claim 1 wherein selecting a relevant application is triggered at least in part by a comparison of user activity information or scheduling information and user location information.

13. The method of claim 12 wherein selecting a relevant application is triggered at least in part by a determination that user activity information or scheduling information share common variables with the user's location within a predefined period of time.

14. The method of claim 1 wherein the user's electronic device is a portable electronic device.

15. The method of claim 14 wherein the relevant application is selected from a plurality of applications available to the user's portable electronic device via an application store.

16. The method of claim 1 wherein personalized contextual information corresponding to the user is received in an automated manner.

17. The method of claim 1 wherein the type of personalized contextual information is manually controlled by the user.

18. The method of claim 1 wherein notifying the user of the existence of the at least one relevant application comprises recommending the at least one relevant application to the user.

19. A system for providing application recommendations to a user of an electronic device comprising computer readable code on at least one non-transitory computer readable medium, wherein the computer readable code is adapted to perform the steps of any one of the preceding claims.

20. A portable electronic device having an operating system adapted for installation of applications, the portable electronic device comprising:
a memory;
a user interface;
a controller coupled to the memory; and
computer readable code stored on a computer-readable medium, wherein the computer readable code, when executed, causes the portable communication device to:
gather user contextual information comprising at least one of: personal interest information, location information, scheduling information, timing information, or information relating to applications installed on the portable electronic device,
transmit the contextual information for incorporation into a cloud based user knowledge base,
receive a recommended application, and
cause the user interface to indicate to the user the existence of the recommended application.
